(19) United States
(12) Patent Application Publication
(10) Pub. No.: US 2022/0048447 A1
(43) Pub. Date: Feb. 17, 2022

(54) WIRE HARNESS

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Takeshi SHIMIZU, Yokkaichi-shi (JP); Hirotaka BABA, Yokkaichi-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 17/276,039

(22) PCT Filed: Sep. 12, 2019
(86) PCT No.: PCT/JP2019/035879

§ 371 Date: Mar. 12, 2021

(30) Foreign Application Priority Data
Sep. 28, 2018 (JP) 2018-185105

(51) Int. Cl. B60R 16/02; H01B 7/00; H02G 1/14

(52) U.S. Cl. CPC B60R 16/0215; H02G 1/14; H01B 7/0045

(57) ABSTRACT

A wire harness, including: an electrical wire; an exterior tube; and a flexible cover that includes: an exterior tube fixing portion that covers an outer peripheral surface of one end of the exterior tube and is fixed to the outer peripheral surface of the one end of the exterior tube, an electrical wire fixing portion that covers an outer peripheral surface of the electrical wire led out from the one end of the exterior tube and is fixed to the outer peripheral surface of the electrical wire, and a connection portion, which is formed by an elastic member of a constant thickness being folded over, that is folded over from the exterior tube fixing portion so as to cover the one end of the exterior tube and extends into the exterior tube, and is furthermore folded over and connected to the electrical wire fixing portion.

### BACKGROUND

The present disclosure relates to a wire harness.

Conventionally, a wire harness in which the outside of an electrical wire member is covered with an exterior member such as a corrugated tube or a resin pipe is known as an example of a wire harness for a vehicle such as a hybrid vehicle or an electric vehicle. Such a wire harness is sometimes routed under the floor of the vehicle and exposed to the outside for example, and therefore in some cases the wire harness is covered with various types of exterior members, and a foam member is also provided between adjacent exterior members in order to prevent foreign matter such as sand from entering between the exterior members and the electrical wire member (e.g., see JP 2016-201336A). With such a configuration, it is possible to reduce the possibility that the electrical wire member is damaged due to rubbing against foreign matter such as sand over a long period of time.

### SUMMARY

Incidentally, with a wire harness such as that described above, there are cases in which the electrical wire member is led out from an end portion of the exterior member and a portion of the electrical wire member is attached to the vehicle in an exposed state, and in such a case, there is concern that foreign matter such as sand may enter between the exterior member and the electrical wire member from the one end portion of the exterior member. Note that foreign matter such as sand entering between the exterior member and the electrical wire member causes damage to the electrical wire member.

An exemplary aspect of the disclosure provides a wire harness capable of favorably protecting an electrical wire member.

A wire harness according to an exemplary aspect includes: an electrical wire; an exterior tube into which the electrical wire is to be inserted; and a flexible cover that includes an exterior tube fixing portion that covers an outer peripheral surface of one end of the exterior tube and is fixed to the outer peripheral surface of the one end of the exterior tube, an electrical wire fixing portion that covers an outer peripheral surface of the electrical wire led out from the one end of the exterior tube and is fixed to the outer peripheral surface of the electrical wire, and a connection portion that is folded over from the exterior tube fixing portion so as to cover the one end of the exterior tube and extends into the exterior member, and is furthermore folded over and connected to the electrical wire fixing portion.

With this configuration, foreign matter such as sand is prevented from entering between the exterior tube and the electrical wire by the flexible cover. Also, the connection portion of the flexible cover is folded over so as to cover the one end of the exterior tube, thereby preventing the electrical wire from rubbing against the edges of the one end of the exterior tube. Also, the connection portion of the flexible cover being folded twice allows the electrical wire to move in the extending direction thereof relative to the exterior tube, and suppresses the case where a large force is being applied to the exterior tube fixing portion, the electrical wire fixing portion, and the electrical wire. Thus, it is possible to favorably protect the electrical wire.

It is preferable that the electrical wire includes a wire that includes a core wire and an insulating coating that coats an outer peripheral surface of the core wire, and a braid that is formed by a plurality of metal strands that surround the wire, and a portion of the braid inside the electrical wire fixing portion is filled with a filling member.

With this configuration, the electrical wires are electromagnetically shielded by the braid. Also, the part of the braid that is inside the electrical wire fixing portion is filled with the filling member, thereby preventing foreign matter such as sand from passing between the metal strands of the braid and entering between the exterior tube and the electrical wire.

It is preferable that a space between the braid and the wire is also filled with the filling member.

With this configuration, the space between the braid and the wires is filled with the filling member, thereby preventing foreign matter such as sand from passing between the braid and the wires and entering between the exterior tube and the electrical wire.

It is preferable that the connection portion of the flexible cover is molded in a state of being folded over twice in a state in which no external force is applied thereto.

With this configuration, the flexible cover is molded such that the connection portion is folded over twice in a state in which no external force is applied, and it is therefore easier to attach than in cases in which, for example, a sheet-shaped flexible cover, which is not molded such that a connection portion that is folded-over twice when molded, is attached in such a way that a connection portion that is folded over twice is formed when attached. That is to say that the shape of the connection portion is set at the molding stage, therefore making attachment is easier than in a case in which the shape of the connection portion is set when being attached.

It is preferable that the flexible cover includes a slit that is formed in a circumferential portion.

With this configuration, a slit is formed in a portion of the flexible cover in the circumferential direction thereof, and therefore, for example, it is possible to attach the flexible cover from a direction that is perpendicular to the extending direction of the electrical wire in the vicinity of the exterior tube, and attaching the flexible cover is easier than in a case in which no slits are formed therein.

According to the wire harness of the present disclosure, it is possible to favorably protect an electrical wire.

### BRIEF DESCRIPTION OF THE DRAWINGS

FIG. 1 is a schematic configuration diagram showing a wire harness according to an embodiment.

FIG. 2 is a partial cross-sectional view of the wire harness according to the embodiment.

FIG. 3 is a perspective view of a flexible cover according to the embodiment.

FIG. 4 is a cross-sectional view taken along line 4-4 in FIG. 2.

### DETAILED DESCRIPTION OF EMBODIMENTS

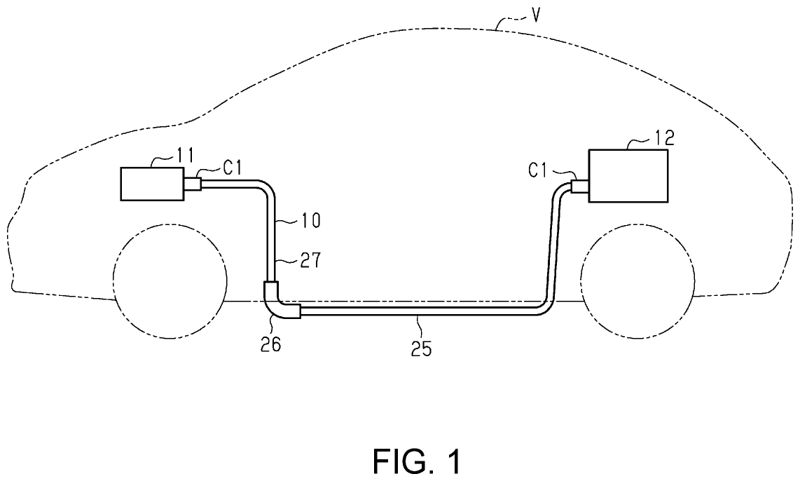

Hereinafter, an embodiment of a wire harness will be described with reference to FIGS. 1 to 4. Note that portions of the configuration may be exaggerated or simplified in the drawings for convenience in the description. Also, the dimensional ratios of portions may differ from the actual dimensional ratios.

As shown in FIG. 1, a wire harness 10 electrically connects two or three or more electrical devices (devices), and in this example, electrically connects an inverter 11, which is installed in the front portion of a vehicle V such as a hybrid vehicle or an electric vehicle, to a high-voltage battery 12 that is installed rearward of the inverter 11 in the vehicle V. The wire harness 10 is routed so as to pass under the floor of the vehicle V, for example, and has one end that is connected to the inverter 11 via one connector C1, and another end that is connected to the high-voltage battery 12 via another connector C1. The inverter 11 is connected to a wheel drive motor (not shown) that is a power source for the traveling of the vehicle. The inverter 11 generates AC power from DC power provided by the high-voltage battery 12, and supplies the AC power to the motor. The high-voltage battery 12 is, for example, a battery capable of supplying a voltage of 100 volts or more.

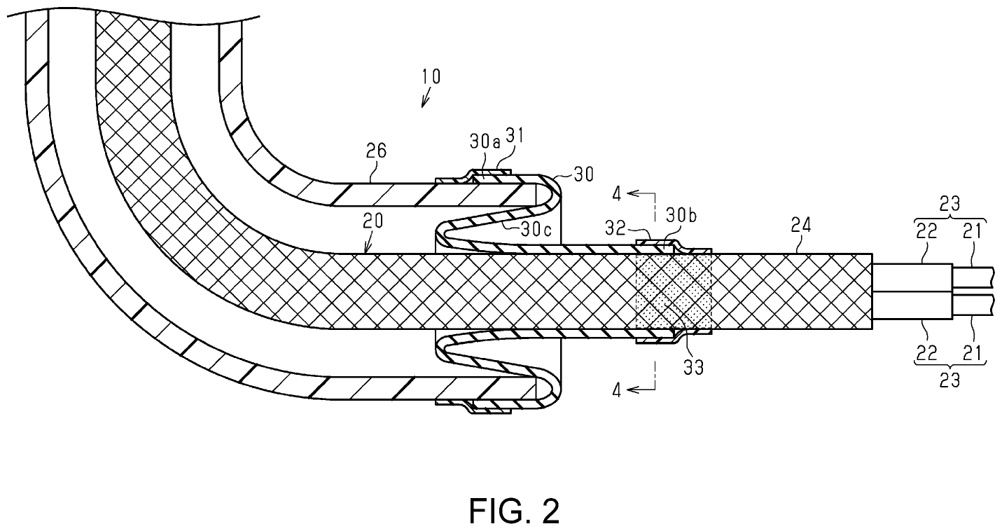

As shown in FIGS. 2 and 4, the wire harness 10 includes an electrical wire member 20 (electrical wire), and the electrical wire member 20 includes a plurality (two in the present embodiment) of wires 23 that have core wires 21 that may be made from a conductive metal and insulating coatings 22 that coat the outer peripheries of the core wires 21, and a braided member 24 (braid) that is constituted by a plurality of metal strands that are braided together and is an electromagnetic shield member that surrounds the wires 23. Note that an aluminum-based metal material is used as the material of the metal strands that constitute the braided member 24 of the present embodiment.

Also, as shown in FIG. 1, the wire harness 10 includes a metal pipe 25, a protector 26, and a corrugated tube 27, as the exterior member (exterior tube) into which the electrical wire member 20 is inserted. The metal pipe 25 is provided so as to cover the electrical wire member 20 that extends from the high-voltage battery 12 and is routed under the floor of the vehicle V. The protector 26 is provided so as to cover a bent portion of the electrical wire member 20 that is on the inverter 11 side of the metal pipe 25. The corrugated tube 27 is provided so as to cover the electrical wire member 20 between the protector 26 and the inverter 11. In some examples, the metal pipe 25 and the protector 26 are directly connected to each other, and in other examples, the metal pipe 25 and the protector 26 are arranged with a space provided therebetween. In some examples, the protector 26 and the corrugated tube 27 are directly connected to each other, and in other examples, the protector 26 and the corrugated tube 27 are arranged with a space provided therebetween.

Also, as shown in FIG. 2, the wire harness 10 includes a flexible cover 30. The flexible cover 30 includes an exterior member fixing portion 30a that covers the outer peripheral surface of one end portion of the protector 26 and is fixed thereto, an electrical wire fixing portion 30b that covers the outer peripheral surface of the electrical wire member 20 led out from the one end portion of the protector 26 and is fixed thereto, and a connection portion 30c that connects the exterior member fixing portion 30a and the electrical wire fixing portion 30b. The connection portion 30c is folded over from the exterior member fixing portion 30a so as to cover the one end portion of the protector 26 and is extends inside of the protector 26, and is folded over again and is connected to the electrical wire fixing portion 30b.

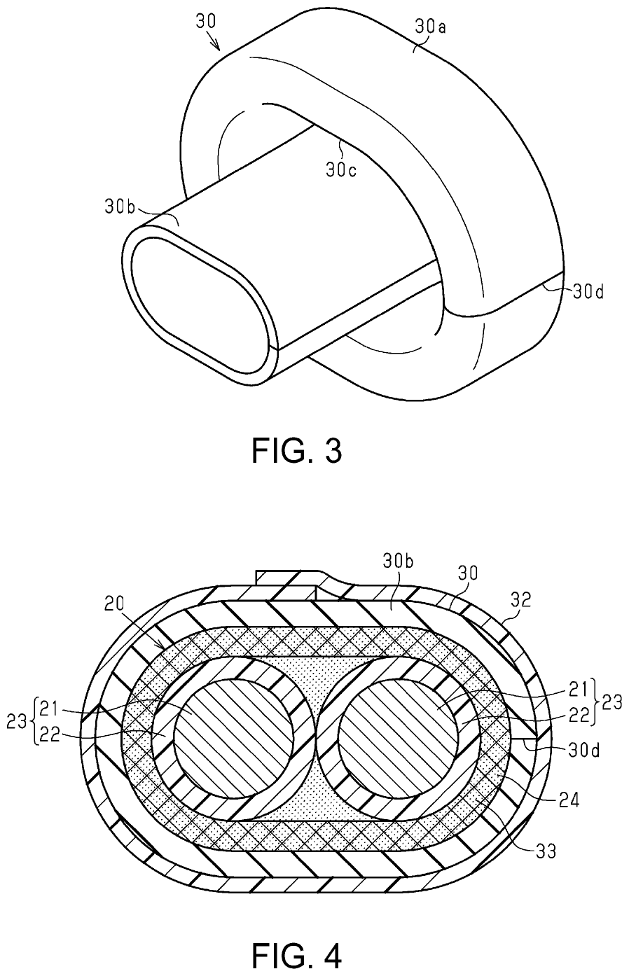

As shown in FIG. 3, the flexible cover 30 of the present embodiment is made from an elastic member such as rubber, and is molded such that the connection portion 30c is folded over twice as described above in a state in which no external force is applied, such as a standalone state before being fixed to the protector 26, the electrical wire member 20, and the like.

Also, a slit 30d is formed in a circumferential portion of the flexible cover 30. As shown in FIG. 3, the flexible cover 30 has a closed shape (also referred to as a closed-ring shape) in which two abutment faces that form the slit 30d are in areal contact with each other. The flexible cover 30 can elastically deform from the closed shape shown in FIG. 3 to an open shape (also referred to as an open-ring shape or a C-shape) in which there is a space between the two abutment faces that form the slit 30d. When the external force that opens the slit 30d is removed, the slit 30d is closed by the elastic reforming force of the flexible cover 30. For example, the slit 30d of the flexible cover 30 can open while the flexible cover 30 is attached to the protector 26 and/or the electrical wire member 20 from a direction that is perpendicular to the extending direction of the electrical wire member 20 in the vicinity of the protector 26, such as from the direction of the electrical wire member 20.

Also, the exterior member fixing portion 30a of the flexible cover 30 is fixed by an adhesive tape 31 that is wound around the exterior member fixing portion 30a and the protector 26 in a state in which the exterior member fixing portion 30a covers the outer peripheral surface of the one end of the protector 26.

Also, the electrical wire fixing portion 30b of the flexible cover 30 is fixed by a piece of adhesive tape 32 that is wound around the electrical wire fixing portion 30b and the electrical wire member 20 in a state in which the electrical wire fixing portion 30b covers the outer peripheral surface of the electrical wire member 20. Note that the electrical wire member 20 that extends from the electrical wire fixing portion 30b is inserted into the metal pipe 25, but the vicinity of the flexible cover 30 is fixed to the vehicle V without being covered by any particular covering such as a water-proofing member, in a state in which it is possible for foreign matter such as sand to come into contact from the outside.

Also, as shown in FIGS. 2 and 4, the part of the braided member 24 of the electrical wire member 20 that is inside the electrical wire fixing portion 30b is filled with adhesive 33 (represented by the dotted hatching in FIGS. 2 and 4) as a filling member. In the present embodiment, the adhesive 33 fills a range that is the same as the range in which the adhesive tape 32 is provided in the extending direction (lengthwise direction) of the electrical wire member 20. Also, as shown in FIG. 4, a space between the braided member 24 and the wires 23 (including in between the wires 23) is filled with the adhesive 33. That is to say, the space between the outer surface layer of the braided member 24 and the outer surface layers of the wires 23 is filled with the adhesive 33 in such a way that no gap remains therebetween.

The following describes the operation of the wire harness 10 configured as described above.

For example, while the vehicle V is traveling, foreign matter such as sand on the ground is sometimes lifted up by the rotating tires, traveling wind, or the like and comes into contact with the wire harness 10. Even though foreign matter such as sand may come into contact with the vicinity of the flexible cover 30, which is the vicinity of the one end portion of the protector 26, the foreign matter is prevented from entering into the protector 26 by the flexible cover 30.

Next, effects of the embodiments described above will be described below.

(1) Foreign matter such as sand is prevented from entering between the protector 26 and the electrical wire member 20 by the flexible cover 30. Also, the connection portion 30c of the flexible cover 30 is folded over so as to cover the one end portion of the protector 26, thereby preventing the edges of the one end portion of the protector 26 from rubbing against the electrical wire member 20 (specifically, against the braided member 24 that constitutes the outer surface layer of the electrical wire member 20). Also, the connection portion 30c of the flexible cover 30 being bent twice allows the electrical wire member 20 to move in the extending direction thereof relative to the protector 26 due to vibrating, for example, and suppresses the case where a large force is applied to the exterior member fixing portion 30a, the electrical wire fixing portion 30b, and the electrical wire member 20. Accordingly, it is possible to favorably protect the electrical wire member 20.

(2) The wires 23 are electromagnetically shielded by the braided member 24. Also, the part of the braided member 24 that is inside the electrical wire fixing portion 30b is filled with the adhesive 33, thereby preventing foreign matter such as sand from passing between the metal strands and entering between the protector 26 and the electrical wire member 20.

(3) The space between the braided member 24 and the wires 23 is also filled with the adhesive 33, thereby preventing foreign matter such as sand from passing between the braided member 24 and the wires 23 and entering between the protector 26 and the electrical wire member 20.

(4) The flexible cover 30 is molded such that the connection portion 30c is folded over twice in a state in which no external force is applied (that is to say, a standalone state before being fixed to the protector 26, the electrical wire member 20, and the like). Accordingly, it is easier to attach the flexible cover 30 in comparison to a case in which, for example, a sheet-shaped flexible cover, which is not molded with a connection portion 30c that is folded-over twice when molded, is attached in such a way that a connection portion is formed when attached that is folded over twice. That is to say that the shape of the connection portion 30c is set at the molding stage, and therefore it is easier to attach the flexible cover 30 than in a case in which the shape of the connection portion 30c is set when being attached (the shape is formed while being inserted between the protector 26 and the electrical wire member 20).

(5) The slit 30d is formed in a circumferential portion of the flexible cover 30, and therefore, for example, it is possible to attach the flexible cover 30 to the protector 26 and/or to the electrical wire member 20 from a direction that is perpendicular to the extending direction of the electrical wire member 20, such as from the electrical wire member 20, in the vicinity of the protector 26, and it is easier to attach the flexible cover 30 than in a case in which the slit 30d is not formed therein.

The present embodiment can be implemented with modifications such as those described below. The present embodiment and the following modified examples can be implemented in combination with each other as long as no technical contradiction arises.
In the embodiment described above, the electrical wire member 20 includes the wires 23 and the braided member 24, but other configurations are also possible as long as the electrical wire member 20 includes at least the wires 23. For example, the braided member 24 may also be an electromagnetic shield member that has a different configuration, or also be an electrical wire member that does not include the electromagnetic shield member (includes only the wires 23). Also, an aluminum-based metal material is used for the metal strands that constitute the braided member 24 of the embodiment described above, but configurations are also possible in which a copper metal material or the like is used.
In the embodiment described above, the part of the braided member 24 that is inside the electrical wire fixing portion 30b is filled with the adhesive 33, but there is no limitation thereto and configurations are also possible in which the braided member 24 is not filled with the adhesive 33. Also, the space between the braided member 24 and the wires 23 (including the spaces between the wires 23) is also filled with the adhesive 33, but there is no limitation thereto, and configurations are also possible in which the space between the braided member 24 and the wires 23 is not filled with the adhesive 33. Also, the adhesive 33 may be changed to another filling member as long as the other filling member has similar functionality as the adhesive 33.
In the embodiment described above, the flexible cover 30 is molded such that a connection portion 30c is folded over twice in a state in which no external force is applied (that is to say, a standalone state before being fixed to the protector 26, the electrical wire member 20, and the like), but there are is no limitation thereto and configurations are also possible in which, for example, the connection portion that is folded over twice at the time of molding is not formed, or in which the connection portion that is folded over twice when attached is formed. Also, in a case such as that described above, the material of the flexible cover 30 may also be changed to another material that is flexible and can bend.
In the embodiment described above, the slit 30d is formed in a portion of the flexible cover 30 in the circumferential direction thereof, but there is no limitation thereto, and configurations are also possible in which the slit 30d is not formed in the flexible cover 30.
In the embodiment described above, the exterior member fixing portion 30a and the electrical wire fixing portion 30b are fixed by the adhesive tape 31 and 32, but there is no limitation thereto, and configurations are also possible in which the exterior member fixing portion 30a and the electrical wire fixing portion 30b are fixed by a binding band. Also, for example, the electrical wire fixing portion 30b may also be fixed by the adhesive 33 that fills the braided member 24.
In the embodiment described above, the wires 23 of the electrical wire member 20 are two wires, but there is no limitation thereto, and the wires 23 may also be one wire, or by three or more wires.
In the embodiment described above, the flexible cover 30 is provided on one end portion of the protector 26 which is one exterior member into which the electrical wire member 20 is inserted, but configurations are also possible in which a flexible cover is similarly provided on an end portion of another exterior member, such as the metal pipe 25 or the corrugated tube 27.
The arrangement relationship of the inverter 11 and the high-voltage battery 12 in the vehicle is not limited to the above embodiment, and may be appropriately changed according to the configuration of the vehicle.
Although the inverter 11 and the high-voltage battery 12 are adopted as the electrical devices connected by the wire harness 10 in the above embodiment, the present disclosure is not limited thereto. For example, the present disclosure may be applied to a wire harness that connects the inverter 11 and the wheel drive motor to each other. In other words, the present disclosure is applicable to any wire harness that electrically connects electrical devices installed in a vehicle.

The present disclosure includes the following implementation examples. Reference numerals have been added to the constituent elements of the embodiments, not for limitation, but to aid in understanding.

Supplementary note 1: The present disclosure includes a flexible sealing grommet (30). The flexible sealing grommet (30) is configured to suppress the entrance of solid foreign matter into the space between an inner peripheral surface of a tubular wire protecting member (25, 26, 27) that has an outer peripheral surface, the inner peripheral surface, and an open end, and an outer peripheral surface of a wire (23) that passes through the tubular wire protecting member (25, 26, 27). The flexible sealing grommet (30) can include:

a radially outward lip (30a) that is configured to come into contact with the entire circumference of the outer peripheral surface of the tubular wire protecting member (25, 26, 27) when the flexible sealing grommet (30) is attached to the open end of the tubular wire protecting member (25, 26, 27);

a radially inward lip (30b) that is configured to come into contact with the entire circumference of the outer peripheral surface of the wire (23) when the flexible sealing grommet (30) is attached to the open end of the tubular wire protecting member (25, 26, 27); and

an annular diaphragm (30c) that spreads out between the radially outward lip (30a) and the radially inward lip (30b), wherein

the flexible sealing grommet (30) can be configured to air-tightly and/or water-tightly seal the space between the inner peripheral surface of the tubular wire protecting member (25, 26, 27) and the outer peripheral surface of the wire (23) at the open end of the tubular wire protecting member (25, 26, 27).

Supplementary note 2: In one or more implementation examples of the present disclosure, the flexible sealing grommet (30) is a one-piece article.

Supplementary note 3: In one or more implementation examples of the present disclosure, the annular diaphragm (30c) can have a zig-zag cross-section in a longitudinal view (see FIG. 2) that is perpendicular to the transverse plane of the tubular wire protecting member (25, 26, 27).

Supplementary note 4: In one or more implementation examples of the present disclosure, the radially outward lip (30a) and the annular diaphragm (30c) can form a first folded-over portion that is configured to accommodate the entire circumference of the open end of the tubular wire protecting member (25, 26, 27).

Supplementary note 5: In one or more implementation examples of the present disclosure, the radially inward lip (30b) and the annular diaphragm (30c) can form a second folded-over portion that is configured to be inserted into the tubular wire protecting member (25, 26, 27) in the axial direction thereof from the open end of the tubular wire protecting member (25, 26, 27).

Supplementary note 6: In one or more implementation examples of the present disclosure, the second folded-over portion can be configured to be able to elastically retract and extend in the radial direction between the inner peripheral surface of the tubular wire protecting member (25, 26, 27) and the outer peripheral surface of the wire (23).

Supplementary note 7: In one or more implementation examples of the present disclosure, the first folded-over portion and the second folded-over portion are configured to allow the radially inward lip (30b) to elastically deform in both the radial direction and the axial direction relative to the radially outward lip (30a).

Supplementary note 8: In one or more implementation examples of the present disclosure, the radially outward lip (30a) can be configured to come into surface contact with the outer peripheral surface of the tubular wire protecting member (25, 26, 27) over a first axial directional length in the axial direction of the tubular wire protecting member (25, 26, 27) and,

the radially inward lip (30b) can be configured to come into surface contact with the outer peripheral surface of the wire (23) over a second axial directional length in the axial direction of the tubular wire protecting member (25, 26, 27), wherein the second axial directional length is longer than the first axial directional length.

Supplementary note 9: In one or more implementation examples of the present disclosure, the flexible sealing grommet (30) can include two abutment faces that form a slit (30d) that crosses the flexible sealing grommet (30) in the axial direction thereof, and the flexible sealing grommet (30) is configured to elastically deform into a closed shape in which the two abutment faces that form the slit (30d) are in areal contact with each other, and elastically deform into an open shape in which a space is formed between the two abutment faces.

Supplementary note 10: The present disclosure includes a wire harness (10) that includes the tubular wire protecting member (25, 26, 27), the wire (23), and the flexible sealing grommet (30).

It will be apparent to those skilled in the art that the present disclosure may be embodied in other specific forms without departing from the technical idea of the disclosure. For example, some of the portions described in the embodiment (or one or more aspects thereof) may be omitted, or some portions may be combined. The scope of the disclosure is intended to be determined with reference to the appended claims, along with the full range of equivalents to which it is entitled.

1. A wire harness, comprising:
an electrical wire;
an exterior tube into which the electrical wire is to be inserted; and
a flexible cover that includes:
an exterior tube fixing portion that covers an outer peripheral surface of one end of the exterior tube and is fixed to the outer peripheral surface of the one end of the exterior tube,
an electrical wire fixing portion that covers an outer peripheral surface of the electrical wire led out from the one end of the exterior tube and is fixed to the outer peripheral surface of the electrical wire, and
a connection portion, which is formed by an elastic member of a constant thickness being folded over, that is folded over from the exterior tube fixing portion so as to cover the one end of the exterior tube and extends into the exterior tube, and is furthermore folded over and connected to the electrical wire fixing portion.

2. The wire harness according to claim 1, wherein
the electrical wire includes a wire that includes a core wire and an insulating coating that coats an outer peripheral surface of the core wire, and a braid that is formed by a plurality of metal strands that surround the wire, and
a portion of the braid inside the electrical wire fixing portion is filled with a filling member.

3. The wire harness according to claim 2, wherein a space between the braid and the wire is also filled with the filling member.

4. The wire harness according to claim 1, wherein the connection portion of the flexible cover is molded in a state of being folded over twice in a state in which no external force is applied thereto.

5. The wire harness according to claim 4, wherein the flexible cover includes a slit that is formed in a circumferential portion.

6. The wire harness according to claim 1, wherein the flexible cover is formed from the elastic member of a constant thickness.

7. The wire harness according to claim 1, wherein the connection portion is an annular diaphragm.

8. The wire harness according to claim 7, wherein the annular diaphragm includes a folded-over portion that can elastically retract and extend in a radial direction between an inner peripheral surface of the exterior tube and the outer peripheral surface of the electrical wire.

9. The wire harness according to claim 1, wherein the electrical wire fixing portion comes into surface contact with the outer peripheral surface of the electrical wire over an axial-direction length in an axial direction of the exterior tube.
